(19) United States
(12) Patent Application Publication
(10) Pub. No.: US 2022/0101273 A1
(43) Pub. Date: Mar. 31, 2022

(54) METHODS AND SYSTEMS FOR FORECASTING ESTIMATED TIME OF RESTORATION DURING SERVICE INTERRUPTION

(71) Applicant: Commonwealth Edison Company, Chicago, IL (US)

(72) Inventors: Carl Chatteron, Chicago, IL (US); David Wilson, Chicago, IL (US); Sarah Burgos, Chicago, IL (US); Tracy Orledge, Chicago, IL (US); Suzanne Belber, Chicago, IL (US); Babak Besharati, Chicago, IL (US); Vladyslav Anderson, Chicago, IL (US)

(21) Appl. No.: 17/491,032

(22) Filed: Sep. 30, 2021

Related U.S. Application Data
(60) Provisional application No. 63/085,710, filed on Sep. 30, 2020.

(51) Int. Cl. G06Q 10/00

(52) U.S. Cl. CPC G06Q 10/20

(57) ABSTRACT

Machine learning may be used to forecast an estimated time of restoration (ETR) during a service interruption. To forecast an ETR, the collection of information from the multiple sources may be provided as inputs to a machine learning model, such as a deep long-short term memory recurrent neural network, a predictive model, and/or the like. The machine learning model may be trained to optimize the temporal cost function of sustained service interruptions and forecast ETRs for service interruptions (in minutes). The machine learning model may process data/information in real-time and provide an ETR when inputs are not yet available in the repair/resolution process, and update (reforecast) the ETR in real-time as the inputs late become available.

### CROSS-REFERENCE TO RELATED APPLICATIONS

This application claims the benefit of U.S. Provisional Application No. 63/085,710, filed Sep. 30, 2020, which is incorporated herein in its entirety.

### BACKGROUND

Services (e.g., electricity services, gas services, water services, telecommunications services, etc.) provided by utilities and/or other service providers may be interrupted. A service interruption may impact customers in vastly different ways. For example, a power outage may cause a residential customer a mere inconvenience, a business may experience a significant loss in revenue, life may be at stake at a medical facility experiencing power loss. The ability to communicate accurate and reliable estimated times of restoration during service interruptions is customers is important for managing the customer experience and/or contingency planning. However, the variability in causes and characteristics of service interruptions makes rule-based calculations and/or determinations of restoration times unreliable and/or erroneous.

### SUMMARY

It is to be understood that both the following general description and the following detailed description are exemplary and explanatory only and are not restrictive. Methods and systems for forecasting estimated time of restoration (ETR) during service interruption are described.

During a service interruption, a collection of information from multiple sources may be used to forecast an estimated time of restoration (ETR). For example, during a power outage that is reported to and/or determined by a service provider, spatial information, temporal information, utility system information, and/or the like may be used to determine and/or forecast an ETR. Spatial information may include details where a source(s) of the outage is located (e.g., latitudes, longitudes, coordinates, etc.) relative to the location of any field service personnel and/or vehicles assigned to repair/resolve the outage. Spatial information may be used to estimate arrival time of any field service personnel and/or vehicles assigned to repair/resolve the outage. Temporal information may include a time a service interruption occurred, a time when any field service personnel and/or vehicles is assigned to repair/resolve the outage, a time when any field service personnel and/or vehicles assigned to repair/resolve the outage is traveling in route to a source of the outage, a time when any field service personnel and/or vehicles assigned to repair/resolve the outage arrives to repair/resolve the outage, and/or the like. Utility information may include any power grid information, device/component information, electrical substation information, and/or any other information associated with any generation, transmission, and/or distribution system associated with the outage. Ancillary information such as weather information, device and/or sensors information, and/or the like may also be used to determine and/or forecast the ETR.

To determine and/or forecast the ETR, the collection of information from the multiple sources may be provided as inputs to a machine learning model, such as a deep long-short term memory recurrent neural network, and/or the like. The machine learning model may be trained to optimize the temporal cost function of sustained service interruptions and forecast ETRs for service interruptions (in minutes). The machine learning model may process data/information in real-time and provide an ETR when inputs are not yet available in the repair/resolution process, and update the ETR in real-time as the inputs are later available.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the methods and systems:

FIG. 1 shows an example system for forecasting an estimated time of restoration (ETR) during a service interruption;

FIG. 2 shows an example machine learning model for forecasting an estimated time of restoration (ETR) during a service interruption;

FIG. 3 shows an example flowchart of a method for training a machine learning model to forecast an estimated time of restoration (ETR) during a service interruption;

FIG. 4 shows an example flowchart of a method for forecasting an estimated time of restoration (ETR) during a service interruption;

FIG. 5 shows an example flowchart of a method for forecasting an estimated time of restoration (ETR) during a service interruption;

FIG. 6 shows an example flowchart of a method for forecasting an estimated time of restoration (ETR) during a service interruption; and

FIG. 7 shows a block diagram of an example computing device for implementing forecasting an estimated time of restoration (ETR) during a service interruption.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

During a service interruption, a collection of information from multiple sources may be used to forecast an estimated time of restoration (ETR). For example, during a power outage that is reported to and/or determined by a service provider, spatial information, temporal information, utility system information, and/or the like may be used to determine and/or forecast an ETR. Spatial information may include details where a source(s) of the outage is located (e.g., latitudes, longitudes, coordinates, etc.) relative to the location of any field service personnel and/or vehicles assigned to repair/resolve the outage. Spatial information may be used to estimate arrival time of any field service personnel and/or vehicles assigned to repair/resolve the outage. Temporal information may include a time a service interruption occurred, a time when any field service personnel (and/or vehicle(s) associated with the field service personnel) is assigned to repair/resolve the service interruption, a time when any field service personnel (and/or vehicle(s) associated with the field service personnel) assigned to repair/resolve the service interruption is traveling in route to a source of the service interruption, a time when any field service personnel (and/or vehicle(s) associated with the field service personnel) assigned to repair/resolve the service interruption arrives to repair/resolve the service interruption, and/or the like. Utility information may include any power grid information, device/component information, electrical substation information, and/or any other information associated with any generation, transmission, and/or distribution system associated with the service interruption. Ancillary information such as weather information, device and/or sensors information, and/or the like may also be used to determine and/or forecast the ETR.

To determine and/or forecast the ETR, the collection of information from the multiple sources may be provided as inputs to a machine learning model, such as a neural network, a recurrent neural network, or a long-short term memory (LSTM) recurrent neural network, a deep neural network, a predictive model, combinations thereof, and/or the like. The machine learning model may be trained to optimize the temporal cost function of sustained service interruptions and forecast ETRs for service interruptions (in minutes). The machine learning model may process data/information in real-time and provide an ETR when inputs are not yet available in the repair/resolution process, and update the ETR in real-time as the inputs late become available.

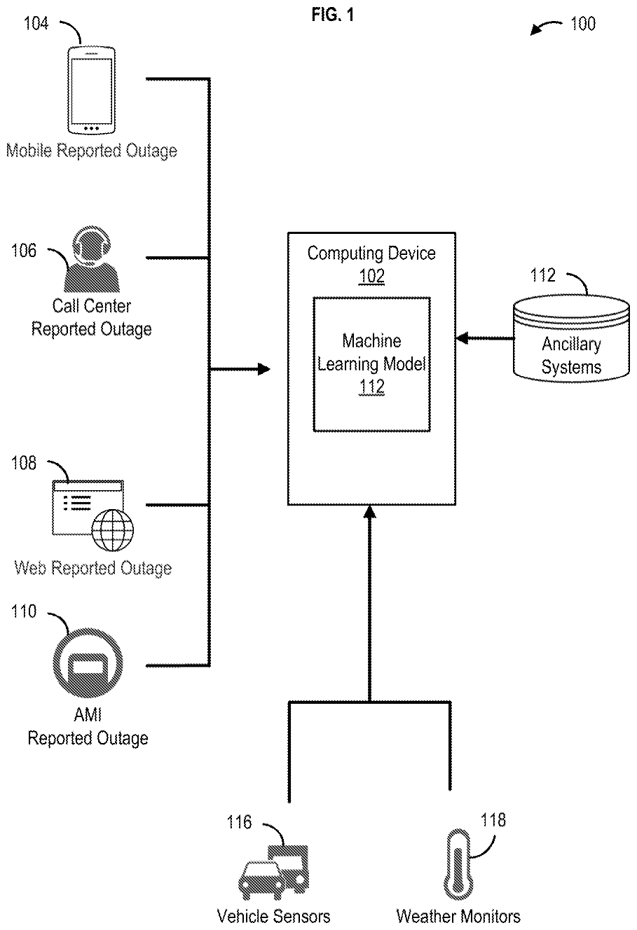

FIG. 1 shows a system 100 that may be configured for forecasting an estimated time of restoration (ETR) during a service interruption. The service interruption may include interruption to electricity service, gas service, water service, telecommunication service, and/or any other service/utility. Machine learning and/or artificial intelligence may be used to predict the duration (in minutes) of a service interruption. The prediction may be based on service interruption information which may include spatial information, temporal information, geographic information, service provider information (e.g., utility/grid statistical information, etc.), real-time data from devices/sensors, and/or the like. A computing device 102 (e.g., a server, a cloud device, a central computing device, etc.) may receive the service interruption information. The computing device 102 may be associated with a service/utility provider and/or utility management system.

The computing device 102 may be configured at (or disposed at) a central location (e.g., a headend, or processing facility) and may receive the service interruption information from a variety of sources. For example, service interruption information may be generated and provided to the computing device 102 by a service customer via a mobile device 104 (or any other communication device), a call center 106 tasked to monitor service interruptions, an online and/or web service 108 configured to monitor/detect service interruptions, an advanced metering infrastructure 110 configured to monitor/detect service interruptions, an ancillary system 114 (e.g., a utility management system (UMS), an online traffic service, a work management system, a geographic information system (GIS), a service interruption management system (OMS), etc.), and/or any other source. In some instances, the computing device 102 may receive information associated with a service interruption from one or more devices and/or sensors (not shown), such as smart meters, power level sensors, fault detection devices, and/or the like associated with the service.

The information associated with the service interruption may include service provider information, spatial information, temporal information, traffic information, weather information, and/or the like. For example, the service provider information may include and/or indicate a type of service (e.g., electricity service, gas service, water service, telecommunication service, etc.) associated with the service interruption. The service provider information may include and/or indicate the cause of the service interruption. For example, service provider information may include and/or indicate the cause of the service interruption as the result of storm (e.g., wind, heat, ice, snow, lightning, etc.) damage, the result of fallen limbs/trees, the result of a vehicle and/or the like colliding with a utility component, the result of an earthquake or any other natural disaster, the result of one or more animals damaging a utility component, the result of excavation and/or digging activities, the result of system exertion (e.g., high power demands, overburdened system components, etc.), and/or the like.

Spatial information may include geospatial characteristics (e.g., latitude and longitude of the service interruption and/or equipment associated with the service interruption, etc.) and/or geographic information, for example, determined by a geographic information system (GIS), and/or the like. The spatial information may include one or more distance measurement between a location of the service interruption and one or more locations of one or more restoration entities (e.g., crew members, field technicians, service drones, third-party maintenance providers, etc.) assigned to resolve the service interruption. The one or more distance measurements may include, for example, distances calculated/determined using Manhattan distance, Euclidean distance, and/or any other geometric and/or distance-based measure. The spatial information may include topographical information associated with one or more routes between the location of the service interruption and the one or more locations of the one or more restoration entities. For example, topographical information and/or the like associated with one or more routes between the location of the service interruption and the one or more locations of the one or more restoration entities may include road segments, road lengths, a road segment grade, a number/quantity of travel lanes, road intersections points, and/or the like. The spatial information may include any other type of spatial information associated with the service interruption.

Temporal information may include and/or indicate a time when the one or more restoration entities (e.g., crew members, field technicians, service drones, third-party maintenance providers, etc.) are assigned to resolve the service interruption, a time when the one or more restoration entities begin to travel to a location associated with the service interruption, or a time when the one or more restoration entities arrive at the location associated with the service interruption. The temporal information may also include calendar and/or holiday information that may affect when one or more restoration entities (e.g., crew members, field technicians, service drones, third-party maintenance providers, etc.) are assigned to restore the service interruption. The temporal information may include any other temporal-based information.

Traffic information may include and/or indicate an average traffic speed associated with the route between the location of the service interruption and the one or more restoration entities (e.g., crew members, field technicians, service drones, third-party maintenance providers, etc.) assigned to resolve the service interruption. The traffic information may include an average traffic density associated with the route between the location of the service interruption and the one or more restoration entities. The traffic information may include real-time travel speed associated with the one or more restoration entities assigned to resolve the service interruption when traveling to the location of the service interruption. The traffic information may include any other traffic-related information.

The computing device 102 may include a machine learning model 112. The machine learning model 112 may be trained to determine, predict, and/or forecast an ETR for service interruption. For example, collection of historical service interruption/outage data, utility data (e.g., grid data, feeder data, substation data, etc.), device and/or sensor data, spatial data, and/or the like may be used to form one or more datasets. The one or more datasets may include labeled data and/or target features (e.g., ordinal features, nominal features, etc.) associated with service interruptions. The one or more datasets may be provided as inputs to the machine learning model 112. Regression (e.g., linear regression, etc.) and/or the like may be used to evaluate the performance of the machine learning model 112 when determining an ETR.

The trained machine learning model 112 may receive information associated with a service interruption from a source (e.g., the mobile device 104, the call center 106, the web service 108, advanced metering infrastructure 110, ancillary systems 114, etc.) and output an ETR. The output ETR may detail, in minutes, a duration before the service interruption is to be resolved.

In some instances, the computing device 102 may update (e.g., reforecast) the ETR. To update the update (e.g., reforecast) the ETR, the computing device 102 (e.g., the machine learning model 112) may receive status data/information from one or more devices, such as one or more vehicle sensors 116 and/or one or more weather monitoring devices 118. The one or more vehicle sensors 116 may include sensors/devices attached to one or more vehicles associated with the one or more restoration entities (e.g., crew members, field technicians, service drones, third-party maintenance providers, etc.) assigned to resolve the service interruption. The status information may indicate the location of the one or more vehicles associated with the one or more restoration entities relative to a location of the service interruption. The one or more weather monitoring devices 118 may monitor weather conditions corresponding to the service interruption. To update the ETR, the computing device 102 (e.g., the machine learning model 112), for example, may determine the probable effect of the weather conditions and/or locations of the one or more vehicles associated with the one or more restoration entities on the ETR. For example, weather conditions such as snow and/or extreme rain may cause the one or more vehicles associated with the one or more restoration entities (e.g., crew members, field technicians, service drones, third-party maintenance providers, etc.) assigned to resolve the service interruption to arrive at the location of the service interruption later than previously forecasted/predicted. The computing device 102 (e.g., the machine learning model 112) may output the updated ETR. For example, the computing device 102 may send the updated ETR to a user device (not shown) and/r cause the user device to display the updated ETR. The updated ETR may be displayed as a timer, countdown, and/or the like.

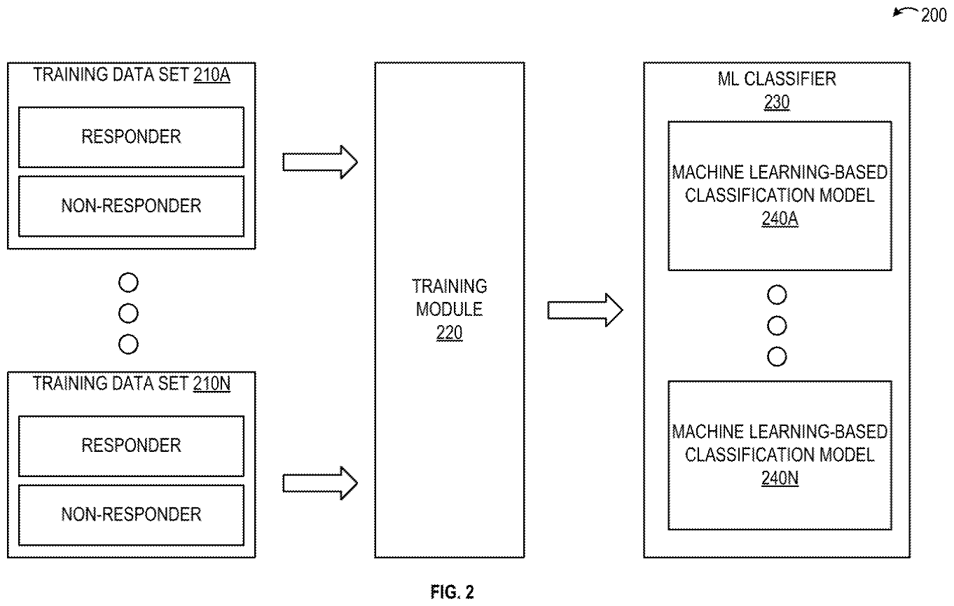

FIG. 2 is an example system 200 for forecasting the estimated time of restoration (ETR) during the service interruption. The system 200 may use machine learning techniques to train, based on an analysis of one or more training datasets 210A-210N by a training module 220, at least one machine learning-based classifier 230 that is configured to classify features extracted from service interruption information. The machine learning-based classifier 230 may classify features extracted from service interruption information to determine an estimated time of restoration (ETR) for service interruption. The service interruption may include interruption to electricity service, gas service, water service, telecommunication service, and/or any other service/utility. Service interruption information may include spatial information, temporal information, geographic information, service provider information (e.g., utility/grid statistical information, etc.), real-time data from devices/sensors, and/or the like.

The one or more training datasets 210A-210N may comprise labeled baseline data such as labeled service interruption type indicators, labeled route and/or road data (e.g., road segments, road lengths, grades of road segments, quantities of traffic lanes, distance measurements, etc.), labeled traffic data, and/or labeled service provider data (e.g., grid information, device/component types, region information, cause of service interruption information, etc.). The labeled baseline data may be associated with historical service interruptions, such as service interruptions occurring over a time period, within a particular region, and/or affecting a type of service. In some instances, labeled datasets may include features extracted from service interruption information and/or the like. In some instances, the labeled baseline data may comprise labeled baseline data from before, during, and/or after a service interruption. The labeled baseline data may include any number of feature sets (labeled data that identify extracted features from service interruption information/data).

The labeled baseline data may be stored in one or more databases. Data for a service interruption may be randomly assigned to a training dataset or a testing dataset. In some implementations, the assignment of data to a training dataset or a testing dataset may not be completely random. In this case, one or more criteria may be used during the assignment, such as ensuring that similar service interruptions, similar restoration activities and/or restoration entity assignments, dissimilar service interruptions, dissimilar restoration activities and/or restoration entity assignments, similar weather conditions, dissimilar weather conditions, and/or the like may be used in each of the training and testing datasets. In general, any suitable method may be used to assign the data to the training or testing datasets.

The training module 220 may train the machine learning-based classifier 230 by extracting a feature set from the labeled baseline data according to one or more feature selection techniques. In some instances, the training module 220 may further define the feature set obtained from the labeled baseline data by applying one or more feature selection techniques to the labeled baseline data in the one or more training datasets 210A-210N. The training module 220 may extract a feature set from the training datasets 210A-210N in a variety of ways. The training module 220 may perform feature extraction multiple times, each time using a different feature-extraction technique. In some instances, the feature sets generated using the different techniques may each be used to generate different machine learning-based classification models 240. In an embodiment, the feature set with the highest quality metrics may be selected for use in training. The training module 220 may use the feature set(s) to build one or more machine learning-based classification models 240A-240N that are configured to forecast an ETR for service interruption.

In some instances, the training datasets 210A-210N and/or the labeled baseline data may be analyzed to determine any dependencies, associations, and/or correlations between service provider information, spatial information, temporal information, traffic information, and/or weather information in the training datasets 210A-210N and/or the labeled baseline data. The term “feature,” as used herein, may refer to any characteristic of an item of data that may be used to determine whether the item of data falls within one or more specific categories. By way of example, the features described herein may comprise route characteristics, service interruption characteristics (e.g., types of interruptions, causes of interruptions, average times to repair service interruptions, reoccurrences of service interruptions, etc.), service/utility provider characteristics (e.g., distribution/maintenance center locations, field service personnel information, device/component characteristics, system characteristics (feeder, substations), etc.), and/or any other characteristics.

In some instances, a feature selection technique may comprise one or more feature selection rules. The one or more feature selection rules may comprise determining which features in the labeled baseline data appear over a threshold number of times in the labeled baseline data and identifying those features that satisfy the threshold as candidate features. For example, any feature that appears greater than or equal to 2 times in the labeled baseline data may be considered as candidate features. Any features appearing less than 2 times may be excluded from consideration as a feature. In some instances, a single feature selection rule may be applied to select features or multiple feature selection rules may be applied to select features. In some instances, the feature selection rules may be applied in a cascading fashion, with the feature selection rules being applied in a specific order and applied to the results of the previous rule. For example, the feature selection rule may be applied to the labeled baseline data to generate an estimated timer of restoration (ETR) for service interruption. A final list of candidate features may be analyzed according to additional features.

In some instances, forecasting an ETR may be based on a wrapper method. A wrapper method may be configured to use a subset of features and train the machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like. In some instances, forward feature selection may be used to identify one or more candidate service interruption restoration times. Forward feature selection is an iterative method that begins with no feature in the machine learning model. In each iteration, the feature which best improves the model is added until addition of a new variable does not improve the performance of the machine learning model. In an embodiment, backward elimination may be used to identify one or more candidate service interruption restoration times. Backward elimination is an iterative method that begins with all features in the machine learning model. In each iteration, the least significant feature is removed until no improvement is observed on the removal of features. In an embodiment, recursive feature elimination may be used to identify one or more candidate service interruption restoration times. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

In some instances, one or more candidate service interruption restoration times may be determined according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to the absolute value of the magnitude of coefficients and ridge regression performs L2 regularization which adds a penalty equivalent to square of the magnitude of coefficients.

After training module 220 has generated a feature set(s), the training module 220 may generate a machine learning-based predictive model 240 based on the feature set(s). The machine learning-based predictive model 240 may be directly based on the datasets 210A-210N. The machine learning-based predictive model, may refer to a complex mathematical model for data classification that is generated using machine-learning techniques. In one example, this machine learning-based classifier may include a map of support vectors that represent boundary features. By way of example, boundary features may be selected from, and/or represent the highest-ranked features in, a feature set. In combination or alone, the machine learning-based model or classifier may be based on the long-short term memory network or another network architecture. The long-short term memory network, as mentioned herein, may receive the datasets 210A-210N and predict the ETR.

In an embodiment, the training module 220 may use the feature sets extracted from the training datasets 210A-210N and/or the labeled baseline data to build a machine learning-based classification model 210A-210N to forecast and/or reforecast ETRs for service interruptions. In some examples, the machine learning-based classification models 240A-240N may be combined into a single machine learning-based classification model 240. Similarly, the machine learning-based classifier 230 may represent a single classifier containing a single or a plurality of machine learning-based classification models 240 and/or multiple classifiers containing a single or a plurality of machine learning-based classification models 240. Also, in some embodiments, the machine learning-based classifier 230 may also include each of the training datasets 210A-210N and/or each feature set extracted from the training datasets 210A-210N and/or extracted from the labeled baseline data.

The extracted features from the service interruption information may be combined in a classification model trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; LSTM models as mentioned herein; a combination thereof and/or the like. The resulting machine learning-based classifier 230 may comprise a decision rule or a mapping that uses service interruption information to forecast and/or reforecast ETRs.

The service interruption information and the machine learning-based classifier 230 may be used to forecast ETRs for the test samples in the test dataset. In one example, the result for each test sample includes a confidence level that corresponds to a likelihood or a probability that the corresponding test sample accurately forecasts an ETR. The confidence level may be a value between zero and one that represents a likelihood that the forecasted ETR consists with a computed value. Multiple confidence levels may be provided for each test sample and for each candidate (approximated) ETR. A top-performing candidate ETR may be determined by comparing the result obtained for each test sample with a computed ETR for each test sample. In general, the top-performing candidate ETRs will have results that closely match the computed ETR. The top-performing candidate ETRs may be used for forecasting and/or reforecasting an ETR during a service interruption.

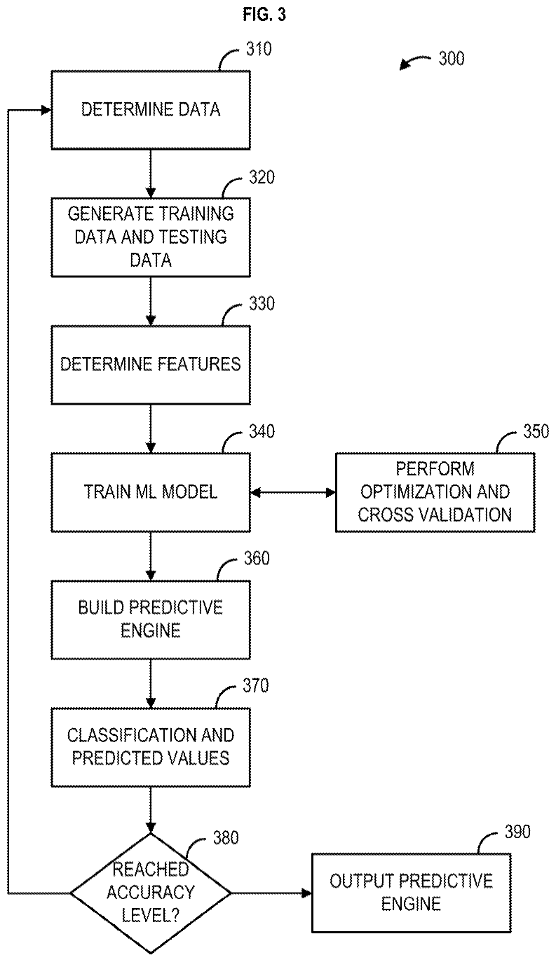

FIG. 3 is a flowchart illustrating an example training method 300 for generating the machine learning classifier 230 using the training module 220. The training module 220 can implement supervised, unsupervised, and/or semi-supervised (e.g., reinforcement-based) machine learning-based classification models 240. The method 300 illustrated in FIG. 3 is an example of a supervised learning method; variations of this example of training method are discussed below, however, other training methods can be analogously implemented to train unsupervised and/or semi-supervised machine learning (predictive) models.

The training method 300 may determine (e.g., access, receive, retrieve, etc.) service interruption data (information) at step 310. The service interruption data may contain one or more datasets, each dataset associated with service provider information, spatial information, temporal information, traffic information, weather information, or any other feature relevant to (e.g., that may affect, etc.) estimated time of restoration during a service interruption. Each dataset may include labeled baseline data.

The training method 300 may generate, at step 320, a training dataset and a testing dataset. The training dataset and the testing dataset may be generated by calculating and/or computing restoration times based on historical service interruption data. In some instances, the training dataset and the testing dataset may be generated by randomly assigning service interruption data to either the training dataset or the testing dataset. In some instances, the assignment of service interruption data as training or test samples may not be completely random. In some instances, only the labeled baseline data for a specific feature extracted from historical service interruption data may be used to generate the training dataset and the testing dataset. In some instances, a majority of the labeled baseline data extracted from service interruption data may be used to generate the training dataset. For example, 75% of the labeled baseline data for forecasting ETRs extracted from the service interruption data may be used to generate the training dataset and 25% may be used to generate the testing dataset. Any method or technique may be used to create the training and testing datasets.

The training method 300 may determine (e.g., extract, select, etc.), at step 330, one or more features that can be used by, for example, a classifier to label features extracted from a variety of service interruption data. The one or more features may comprise service provider data, spatial data, temporal data, traffic data, weather data, or any other data relevant to (e.g., that may affect, etc.) an ETR during a service interruption. In some instances, the training method 300 may determine a set of training baseline features from the training dataset. Features of service interruption data may be determined by any method.

The training method 300 may train one or more machine learning models using the one or more features at step 340. In some instances, the machine learning models may be trained using supervised learning. In another embodiment, other machine learning techniques may be employed, including unsupervised learning and semi-supervised. The machine learning models trained at step 340 may be selected based on different criteria (e.g., how close a forecasted ETR is to an actual restoration time for a service interruption, etc.) and/or data available in the training dataset. For example, machine learning classifiers can suffer from different degrees of bias. Accordingly, more than one machine learning model can be trained at step 340, optimized, improved, and cross-validated at step 350.

The training method 300 may select one or more machine learning models to build a predictive model at step 360 (e.g., a machine learning classifier, a predictive model, etc.). The predictive engine may be evaluated using the testing dataset. The predictive engine may analyze the testing dataset and generate forecasted values and/or predicted values at step 370. Forecasted and/or prediction values may be evaluated at step 380 to determine whether such values have achieved the desired accuracy level. The performance of the predictive engine may be evaluated by comparing the relative error between the actual time of restoration and the predicted ETR. Error metrics, including mean squared error, mean absolute error, and root mean squared error may be used for model selection. For example, a regressor with the lowest mean squared error would be selected as having the highest predictive power for the predictive engine. When such a desired accuracy level is reached, the training phase ends and the predictive engine may be output at step 390; when the desired accuracy level is not reached, however, then a subsequent iteration of the training method 300 may be performed starting at step 310 with variations such as, for example, considering a larger collection of service interruption data.

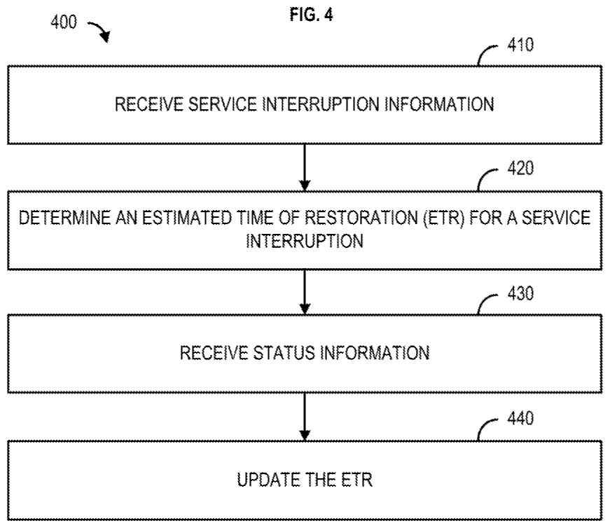

FIG. 4 is a flowchart of an example method 400 for forecasting the estimated time of restoration (ETR) during service interruption. At step 410, service interruption information may be received. A computing device (e.g., a server, a cloud device, a central computing device, a machine learning model, the computing device 102, etc.) may receive service interruption information based on interruption to a service, such as an electricity service, a gas service, a water service, a telecommunication service, and/or any other service or utility. The computing device may receive the service interruption information from a variety of sources.

For example, service interruption information may be generated and provided to the computing device by a service customer via a mobile device (or any other communication device), a call center tasked to monitor service interruptions, an online and/or web service configured to monitor/detect service interruptions, an advanced metering infrastructure configured to monitor/detect service interruptions, an ancillary system (e.g., a utility management system (UMS), an online traffic service, a work management system, a geographic information system (GIS), an outage management system (OMS), etc.), and/or any other source. In some instances, the computing device may receive information associated with a service interruption from one or more devices and/or sensors, such as smart meters, power level sensors, fault detection devices, and/or the like associated with the service.

The information associated with the service interruption may include service provider information, spatial information, temporal information, traffic information, weather information, and/or the like. For example, the service provider information may include and/or indicate a type of service (e.g., electricity service, gas service, water service, telecommunication service, etc.) associated with the service interruption. The service provider information may include and/or indicate the cause of the service interruption. For example, service provider information may include and/or indicate the cause of the service interruption as the result of storm (e.g., wind, heat, ice, snow, lightning, etc.) damage, the result of fallen limbs/trees, the result of a vehicle and/or the like colliding with a utility component, the result of an earthquake or any other natural disaster, the result of one or more animals damaging a utility component, the result of excavation and/or digging activities, the result of system exertion (e.g., high power demands, overburdened system components, etc.), and/or the like.

Spatial information may include geospatial characteristics (e.g., latitude and longitude of the service interruption and/or equipment associated with the service interruption, etc.) and/or geographic information, for example, determined by a geographic information system (GIS), and/or the like. The spatial information may include one or more distance measurement between a location of the service interruption and one or more locations of one or more restoration entities (e.g., crew members, field technicians, service drones, third-party maintenance providers, etc.) assigned to resolve the service interruption. The one or more distance measurements may include, for example, distances calculated/determined using Manhattan distance, Euclidean distance, and/or any other geometric and/or distance-based measure. The spatial information may include topographical information associated with one or more routes between the location of the service interruption and the one or more locations of the one or more restoration entities. For example, topographical information and/or the like associated with one or more routes between the location of the service interruption and the one or more locations of the one or more restoration entities may include road segments, road lengths, a road segment grade, a number/quantity of travel lanes, road intersections points, and/or the like. The spatial information may include any other type of spatial information associated with the service interruption.

Temporal information may include and/or indicate a time when the one or more restoration entities (e.g., crew members, field technicians, service drones, third-party maintenance providers, etc.) are assigned to resolve the service interruption, a time when the one or more restoration entities begin to travel to a location associated with the service interruption, or a time when the one or more restoration entities arrive at the location associated with the service interruption. The temporal information may also include calendar and/or holiday information that may affect when one or more restoration entities (e.g., crew members, field technicians, service drones, third-party maintenance providers, etc.) are assigned to restore the service interruption. The temporal information may include any other temporal-based information.

Traffic information may include and/or indicate an average traffic speed associated with the route between the location of the service interruption and the one or more restoration entities (e.g., crew members, field technicians, service drones, third-party maintenance providers, etc.) assigned to resolve the service interruption. The traffic information may include an average traffic density associated with the route between the location of the service interruption and the one or more restoration entities. The traffic information may include real-time travel speed associated with the one or more restoration entities assigned to resolve the service interruption when traveling to the location of the service interruption. The traffic information may include any other traffic-related information.

At step 420, estimated time of restoration (ETR) for the service interruption may be determined. The computing device may determine an estimated time of restoration (ETR) for the service interruption. The computing device may determine the ETR based on the service interruption information. The computing device may include a machine learning model. The machine learning model may be trained to determine, predict, and/or forecast an ETR for service interruption. The computing device may output the ETR. The computing device may send data indicative of the ETR to a user device (e.g., a mobile device, a smart device, a computing device, etc.). Sending the data indicative of the ETR to the user device may cause the user device to display the ETR, for example, a countdown, a timer, and/or the like.

At step 430, status information may be received. The computing device may receive status information. The computing device may receive the status information from one or more devices associated with the service interruption. The one or more devices may include one or more sensors attached to one or more vehicles associated with one or more restoration entities assigned to resolve the service interruption. The status information may indicate one or more locations for the one or more devices, such as how far from the location of the service interruption the one or more devices are at any given time. In some instances, the one or more devices may include one or more weather sensors and/or weather detection devices. The status information may indicate one or more weather conditions that may affect the ETR.

At step 440, the ETR may be updated. The computing device may use the machine learning model to update the ETR. The ETR may be updated based on the status information. For example, the status information may indicate that the one or more devices (one or more restoration entities) are at a location away from the location of the service interruption, and therefore are the one or more restoration entities are unable to begin restoration activities to resolve the service interruption. In some instances, the status information may indicate one or more weather conditions affecting the ETR. For example, severe storm conditions may cause the arrival of the one or more restoration entities to the location of the service interruption to be delayed. The delayed arrival of the one or more restoration entities may extend the ETR further than originally forecasted. After service is restored, at least a portion of the data may be used to retrain the prediction model (e.g., LSTM model) based on the actual return to service and the surrounding circumstances (e.g., service interruption information, spatial information, temporal information, traffic information, other information available).

The computing device may continue to update the ETR, in real-time, based on additional status information. The computing device may send data indicative of the updated ETR to the user device (e.g., mobile device, smart device, computing device, etc.) or any other device. Sending the data indicative of the updated ETR to the user device may cause the user device to display the updated ETR, for example, as a countdown, a timer, and/or the like.

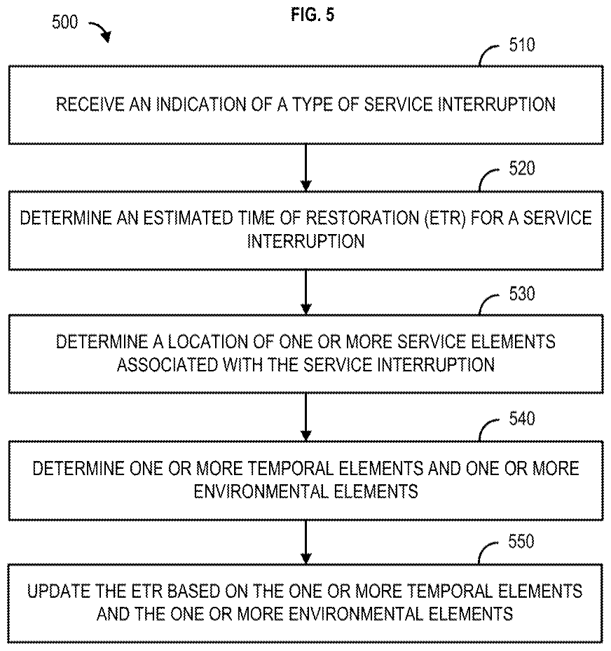

FIG. 5 is a flowchart of an example method 500 for forecasting the estimated time of restoration (ETR) during a service interruption. At step 510, an indication of a type of service interruption may be received. A computing device (e.g., a server, a cloud device, a central computing device, a machine learning model, the computing device 102, etc.) may receive service interruption information that indicates the service interruption. The service interruption may be an interruption to a service, such as an electricity service, a gas service, a water service, a telecommunication service, and/or any other service or utility. The computing device may receive the service interruption information from a variety of sources.

For example, service interruption information may be generated and provided to the computing device by a service customer via a mobile device (or any other communication device), a call center tasked to monitor service interruptions, an online and/or web service configured to monitor/detect service interruptions, an advanced metering infrastructure configured to monitor/detect service interruptions, an ancillary system (e.g., a utility management system (UMS), an online traffic service, a work management system, a geographic information system (GIS), an outage management system (OMS), etc.), and/or any other source. In some instances, the computing device may receive information associated with a service interruption from one or more devices and/or sensors, such as smart meters, power level sensors, fault detection devices, and/or the like associated with the service.

The information associated with the service interruption may include service provider information, spatial information, temporal information, traffic information, weather information, and/or the like. For example, the service provider information may include and/or indicate a type of service (e.g., electricity service, gas service, water service, telecommunication service, etc.) associated with the service interruption. The service provider information may include and/or indicate the cause of the service interruption. For example, service provider information may include and/or indicate the cause of the service interruption as the result of storm (e.g., wind, heat, ice, snow, lightning, etc.) damage, the result of fallen limbs/trees, the result of a vehicle and/or the like colliding with a utility component, the result of an earthquake or any other natural disaster, the result of one or more animals damaging a utility component, the result of excavation and/or digging activities, the result of system exertion (e.g., high power demands, overburdened system components, etc.), and/or the like.

Spatial information may include geospatial characteristics (e.g., latitude and longitude of the service interruption and/or equipment associated with the service interruption, etc.) and/or geographic information, for example, determined by a geographic information system (GIS), and/or the like. The spatial information may include one or more distance measurement between a location of the service interruption and one or more locations of one or more restoration entities (e.g., crew members, field technicians, service drones, third-party maintenance providers, etc.) assigned to resolve the service interruption. The one or more distance measurements may include, for example, distances calculated/determined using Manhattan distance, Euclidean distance, and/or any other geometric and/or distance-based measure. The spatial information may include topographical information associated with one or more routes between the location of the service interruption and the one or more locations of the one or more restoration entities. For example, topographical information and/or the like associated with one or more routes between the location of the service interruption and the one or more locations of the one or more restoration entities may include road segments, road lengths, a road segment grade, a number/quantity of travel lanes, road intersections points, and/or the like. The spatial information may include any other type of spatial information associated with the service interruption.

Temporal information may include and/or indicate a time when the one or more restoration entities (e.g., crew members, field technicians, service drones, third-party maintenance providers, etc.) are assigned to resolve the service interruption, a time when the one or more restoration entities begin to travel to a location associated with the service interruption, or a time when the one or more restoration entities arrive at the location associated with the service interruption. The temporal information may also include calendar and/or holiday information that may affect when one or more restoration entities (e.g., crew members, field technicians, service drones, third-party maintenance providers, etc.) are assigned to restore the service interruption. The temporal information may include any other temporal-based information.

Traffic information may include and/or indicate an average traffic speed associated with the route between the location of the service interruption and the one or more restoration entities (e.g., crew members, field technicians, service drones, third-party maintenance providers, etc.) assigned to resolve the service interruption. The traffic information may include an average traffic density associated with the route between the location of the service interruption and the one or more restoration entities. The traffic information may include real-time travel speed associated with the one or more restoration entities assigned to resolve the service interruption when traveling to the location of the service interruption. The traffic information may include any other traffic related information.

At step 520, an estimated time of restoration (ETR) for the type of service interruption may be determined. The computing device may determine an estimated time of restoration (ETR) for the type service interruption. The computing device may include and/or be configured with a machine learning model (predictive model). The machine learning model may be trained on a plurality of datasets formed from historical service interruption data. The machine learning model may be trained to optimize the temporal cost function of sustained service interruptions and forecast ETRs for service interruptions (in minutes). The machine learning model may process the service interruption information and output an ETR based on the type of service interruption. The computing device may send data indicative of the ETR to a user device (e.g., a mobile device, a smart device, a computing device, etc.). Sending the data indicative of the ETR to the user device may cause the user device to display the ETR, for example, a countdown, a timer, and/or the like.

At step 530, a location of one or more service elements associated with the service interruption may be determined. The computing device may determine the location of the one or more service elements associated with the service interruption. The one or more service elements may include one or more sensors attached to one or more vehicles associated with one or more restoration entities assigned to resolve the service interruption. As an example, the service elements may include bucket trucks or other repair vehicles (e.g., helocopters, vehicles, drones) associated with the service interruption that may be further used to predict the ETR.

At step 540, one or more temporal elements associated with the service interruption and one or more environmental elements associated with the service interruption may be determined. The status information may indicate the one or more temporal elements associated with the service interruption and the one or more environmental elements associated with the service interruption. The computing device may determine the one or more temporal elements associated with the service interruption and the one or more environmental elements associated with the service interruption from the status information. The one or more temporal elements, for example, may include a time the service interruption occurred, a time when any field service personnel and/or vehicles (e.g., a restoration entity, etc.) is assigned to repair/resolve the service interruption, a time when any field service personnel and/or vehicles assigned to repair/resolve the service interruption is traveling in route to a source of the service interruption, a time when any field service personnel and/or vehicles assigned to repair/resolve the service interruption arrives to repair/resolve the service interruption, and/or the like. The one or more environmental elements, for example, may include weather conditions, route topography, and/or the like. The one or more service elements may include one or more weather sensors and/or weather detection devices that detect and/or determine one or more weather conditions may affect the ETR and/or any other environmental conditions. For example, the one or more service elements may include sensors (e.g., light and radar (LIDAR) sensors, ultrasonic sensors, imaging sensors, etc.) that detect/determine route topography, such as dangerous and/or non-travelable terrain, water bodies (e.g., rivers, lakes, etc.), a quantity of traffic lanes, and/or the like.

At step 550, the ETR may be updated. The computing device may use the machine learning model to update the ETR. The ETR may be updated based on the one or more temporal elements and the one or more environmental elements. For example, the one or more temporal elements may indicate that the one or more devices (one or more restoration entities) are at a location away from the location of the service interruption, and therefore are the one or more restoration entities are unable to begin restoration activities to resolve the service interruption. The one or more environmental elements may indicate one or more weather conditions affecting the ETR. For example, severe storm conditions may cause the arrival of the one or more restoration entities to the location of the service interruption to be delayed. The delayed arrival of the one or more restoration entities may extend the ETR further than originally forecasted.

The computing device may continue to update the ETR, in real-time, based on additional status information. The computing device may send data indicative of the updated ETR to the user device (e.g., mobile device, smart device, computing device, etc.) or any other device. Sending the data indicative of the updated ETR to the user device may cause the user device to display the updated ETR, for example, as a countdown, a timer, and/or the like.

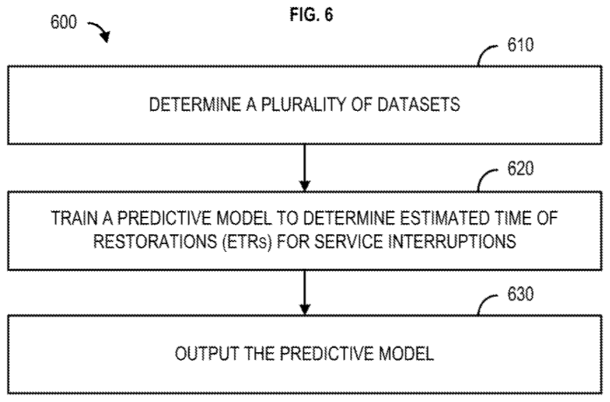

FIG. 6 is a flowchart of an example method 600 for training a machine learning model to forecast an estimated time of restoration (ETR) during a service interruption. At step 610, a plurality of datasets may be determined. The plurality of datasets may be determined, for example, from information received from each source of a plurality of sources. The plurality of sources may include a utility management system (UMS), an online traffic service, a work management system, a geographic information system (GIS), a service interruption management system (OMS), call centers, mobile/user devices, an application, a cloud database, and/or any other source. The plurality of datasets may be based on historical service interruptions, such as service interruptions occurring over a time period, within a particular region, and/or affecting a type of service. Types of service may include electricity service, gas service, water service, telecommunication service, and/or any other type of service.

The information received from each source of the plurality of sources may include one or more of: service provider information, spatial information, temporal information, traffic information, weather information, and/or any other type of information associated with service interruptions. Service provider information may indicate one or more of: a cause of one or more service interruptions, one or more types of services associated with the one or more service interruption, one or more locations associated with one or more service interruptions, restoration information associated with one or more service interruptions. Spatial information may include one or more distance measurements between one or more locations of one or more service interruptions and one or more locations of one or more restoration entities assigned to resolve the one or more service interruptions, and topographical information associated with one or more routes between the one or more locations of the one or more service interruptions and the one or more locations of the one or more restoration entities. Temporal information may include one or more of: one or more times when one or more restoration entities are assigned to resolve one or more service interruptions, or one or more time durations associated with travel by the one or more restoration entities to the one or more service interruptions. Traffic information may include average traffic speeds associated with one or more routes between one or more locations of one or more service interruptions and one or more restoration entities assigned to resolve the one or more service interruptions.

The plurality of datasets may be labeled with service interruption type indicators, labeled route and/or road data (e.g., road segments, road lengths, grades of road segments, quantities of traffic lanes, distance measurements, etc.), labeled traffic data, and/or labeled service provider data (e.g., grid information, device/component types, region information, cause of service interruption information, etc.). The labeled datasets may comprise labeled data from before, during, and/or after one or more service interruptions. The labeled datasets may include any number of feature sets (labeled data that identify extracted features from service interruption information/data).

At step 620, a predictive model may be trained to estimate a time of restoration (ETR) for service interruption. The predictive model may be trained based the information received from each source of the plurality of sources and the plurality of datasets (the labeled datasets). The labeled datasets may be randomly assigned to a training dataset or a testing dataset. Features associated with service interruptions and/or service restorations be extracted from the labeled datasets. One or more feature selection techniques the labeled datasets used as training datasets. Features may be extracted multiple times, each time using a different feature-extraction technique. In some instances, feature sets generated using the different techniques may each be used to generate different machine learning-based classification models for forecasting ETRs. The feature set with the highest quality metrics may be selected for use for training.

At step 620, a predictive model may provide an output. The predictive model may optimize the temporal cost function of sustained service interruptions and forecast ETRs for service interruptions (in minutes). The predictive model may process data/information in real-time and provide an ETR when inputs are not yet available in the repair/resolution process, and update (reforecast) the ETR in real-time as the inputs late become available.

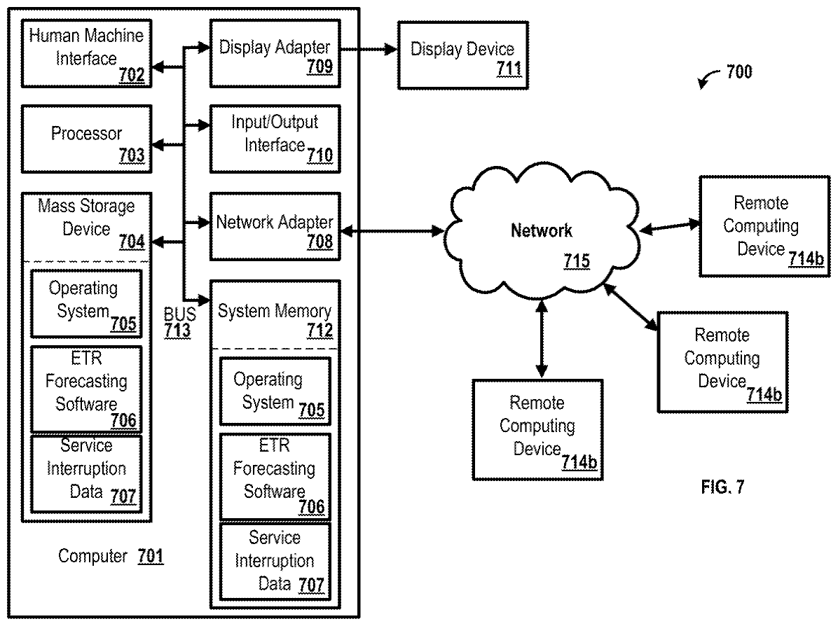

FIG. 7 shows a system 700 for forecasting an estimated time of restoration (ETR) during service interruption. Any device and/or component described herein may be a computer 701 as shown in FIG. 7.

The computer 701 may comprise one or more processors 703, a system memory 712, and a bus 713 that couples various components of the computer 701 including the one or more processors 703 to the system memory 712. In the case of multiple processors 703, the computer 701 may utilize parallel computing.

The bus 713 may comprise one or more of several possible types of bus structures, such as a memory bus, memory controller, a peripheral bus, an accelerated graphics port, and a processor or local bus using any of a variety of bus architectures.

The computer 701 may operate on and/or comprise a variety of computer readable media (e.g., non-transitory). Computer readable media may be any available media that is accessible by the computer 701 and comprises, non-transitory, volatile and/or non-volatile media, removable and non-removable media. The system memory 712 has computer readable media in the form of volatile memory, such as random access memory (RAM), and/or non-volatile memory, such as read only memory (ROM). The system memory 712 may store data such as service interruption data 707 and/or program modules such as operating system 705 and ETR forecasting software 706 that are accessible to and/or are operated on by the one or more processors 703.

The computer 701 may also comprise other removable/non-removable, volatile/non-volatile computer storage media. The mass storage device 704 may provide non-volatile storage of computer code, computer readable instructions, data structures, program modules, and other data for the computer 701. The mass storage device 704 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 704. An operating system 705 and ETR forecasting software 706 may be stored on the mass storage device 704. One or more of the operating system 705 and ETR forecasting software 706 (or some combination thereof) may comprise program modules and the ETR forecasting software 706. Service interruption data 707 may also be stored on the mass storage device 704. Service interruption data 707 may be stored in any of one or more databases known in the art. The databases may be centralized or distributed across multiple locations within the network 715.

A user may enter commands and information into the computer 701 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 703 via a human-machine interface 702 that is coupled to the bus 713, but may be connected by other interface and bus structures, such as a parallel port, game port, an IEEE 1394 Port (also known as a Firewire port), a serial port, network adapter 708, and/or a universal serial bus (USB).

A display device 711 may also be connected to the bus 713 via an interface, such as a display adapter 709. It is contemplated that the computer 701 may have more than one display adapter 709 and the computer 701 may have more than one display device 711. A display device 711 may be a monitor, an LCD (Liquid Crystal Display), light emitting diode (LED) display, television, smart lens, smart glass, and/or a projector. In addition to the display device 711, other output peripheral devices may comprise components such as speakers (not shown) and a printer (not shown) which may be connected to the computer 701 via Input/Output Interface 710. Any step and/or result of the methods may be output (or caused to be output) in any form to an output device. Such output may be any form of visual representation, including, but not limited to, textual, graphical, animation, audio, tactile, and the like. The display 711 and computer 701 may be part of one device, or separate devices.

The computer 701 may operate in a networked environment using logical connections to one or more remote computing devices 714a,b,c. A remote computing device 714a,b,c may be a personal computer, computing station (e.g., workstation), portable computer (e.g., laptop, mobile phone, tablet device), smart device (e.g., smartphone, smartwatch, activity tracker, smart apparel, smart accessory), security and/or monitoring device, a server, a router, a network computer, a peer device, edge device or other common network nodes, and so on. Logical connections between the computer 701 and a remote computing device 714a,b,c may be made via a network 715, such as a local area network (LAN) and/or a general wide area network (WAN). Such network connections may be through a network adapter 708. A network adapter 708 may be implemented in both wired and wireless environments. Such networking environments are conventional and commonplace in dwellings, offices, enterprise-wide computer networks, intranets, and the Internet.

Application programs and other executable program components such as the operating system 705 are shown herein as discrete blocks, although it is recognized that such programs and components may reside at various times in different storage components of the computing device 701, and are executed by the one or more processors 703 of the computer 701. An implementation of ETR forecasting software 706 may be stored on or sent across some form of computer-readable media. Any of the disclosed methods may be performed by processor-executable instructions embodied on computer-readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, by a computing device, based on a service interruption, service interruption information;
determining, based on the service interruption information, an estimated time of restoration (ETR) for the service interruption;
receiving, from one or more devices associated with the service interruption, status information, wherein the status information indicates one or more locations for the one or more devices; and
updating, based on the status information, the ETR.

2. The method of claim 1, wherein receiving the service interruption information comprises receiving the service interruption information from one or more of: a mobile device, a call center, an online service, or an application.

3. The method of claim 1, wherein the service interruption information comprises one or more of service provider information, spatial information, temporal information, traffic information, or weather information.

4. The method of claim 3, wherein the service provider information indicates one or more of: a cause of the service interruption, a type of service associated with the service interruption, one or more locations associated with the service interruption, or the one or more devices.

5. The method of claim 3, wherein the spatial information comprises a distance measurement between a location of the service interruption and one or more locations of one or more restoration entities assigned to resolve the service interruption, and topographical information associated with one or more routes between the location of the service interruption and the one or more locations of the one or more restoration entities.

6. The method of claim 3, wherein the temporal information indicates one or more of a time when one or more restoration entities are assigned to resolve the service interruption, a time when the one or more restoration entities begin travel to a location associated with the service interruption, or a time when the one or more restoration entities arrive at the location associated with the service interruption.

7. The method of claim 3, wherein the traffic information indicates an average traffic speed associated with a route between a location of the service interruption and one or more restoration entities assigned to resolve the service interruption, an average traffic density associated with the route between the location of the service interruption and the one or more restoration entities, an real-time travel speed associated with the one or more restoration entities assigned to resolve the service interruption.

8. The method of claim 3, wherein the service comprises an electricity service, a gas service, a water service, or a telecommunication service.

9. The method of claim 1, wherein determining the ETR comprises:
inputting, to a trained predictive model, the service interruption information; and
outputting, via the trained predictive learning model, the ETR.

10. The method of claim 1, further comprising causing display of one or more of the ETR or the updated ETR.

11. The method of claim 1, wherein the one or more devices comprises one or more sensors attached to one or more vehicles associated with one or more restoration entities assigned to resolve the service interruption.

12. A method comprising:
receiving an indication of a type of service interruption;
determining, based on historical data associated with the type of service interruption, an estimated time of restoration (ETR) for the service interruption;
determining a location of one or more service elements associated with the service interruption;
determining, based on the location of the one or more service elements, one or more temporal elements associated with the service interruption and one or more environmental elements associated with the service interruption; and
updating, based on the one or more temporal elements and the one or more environmental elements, the ETR.

13. The method of claim 12, wherein the one or more service elements comprise a service device or a service vehicle.

14. The method of claim 12, wherein the one or more temporal elements associated with the service interruption comprises one or more of: a time that notification associated with the indication of the service interruption was sent to the one or more service elements, or an average travel speed associated with the one or more service elements.

15. The method of claim 12, wherein the one or more environmental elements associated with the service interruption comprise one or more weather conditions associated with one or more of a location associated with the service interruption or a route to with the location associated with the service interruption.

16. A method comprising:
determining, for information received from each source of a plurality of sources, a dataset of a plurality of datasets, wherein the information received from each source of the plurality of sources comprises one or more of service provider information, spatial information, temporal information, traffic information, or weather information;
training, based the information received from each source of the plurality of sources and the plurality of datasets, a predictive model to estimate a time of restoration (ETR) for a service interruption; and
outputting the predictive model.

17. The method of claim 16, wherein the service provider information indicates one or more of: a cause of one or more service interruptions, one or more types of services associated with the one or more service interruptions, one or more locations associated with one or more service interruptions, restoration information associated with one or more service interruptions.

18. The method of claim 16, wherein the spatial information comprises one or more distance measurements between one or more locations of one or more service interruptions and one or more locations of one or more restoration entities assigned to resolve the one or more service interruptions, and topographical information associated with one or more routes between the one or more locations of the one or more service interruptions and the one or more locations of the one or more restoration entities.

19. The method of claim 16, wherein the temporal information indicates one or more of: one or more times when one or more restoration entities are assigned to resolve one or more service interruptions, or one or more time durations associated with travel by the one or more restoration entities to the one or more service interruptions.

20. The method of claim 16, wherein the traffic information indicates average traffic speeds associated with one or more routes between one or more locations of one or more service interruptions and one or more restoration entities assigned to resolve the one or more service interruptions.
